(19) United States
(12) Patent Application Publication
(10) Pub. No.: US 2015/0007142 A1
(43) Pub. Date: Jan. 1, 2015

(54) BRANCH DESTINATION TABLES

(71) Applicant: Google Inc., Mountian View, CA (US)

(72) Inventors: Cliff L. Biffle, Berkeley, CA (US); Bennet S. Yee, Mountain View, CA (US)

(21) Appl. No.: 13/712,700

(22) Filed: Dec. 12, 2012

(51) Int. Cl. G06F 11/36

(52) U.S. Cl. CPC G06F 11/3668
USPC 717/126

(57) ABSTRACT

Methods, systems, and apparatus, including computer programs encoded on computer storage media, for software sandboxing. One of the methods includes receiving a software module that includes verifiably safe computer code and a branch destination table indicating addresses of all instructions that may be targets of indirect control flow transfers; validating the computer code to determine whether it can run safely by using a statically verifiable fault isolation scheme, where validating the computer code comprises validating the addresses of the branch destination table instructions; and running the computer code, in a sandbox environment, if it has been determined to run safely.

### BACKGROUND

This instant specification relates to software sandboxing.

A computer sandbox or sandbox environment is a mechanism often used for separating running programs. A conventional sandbox environment may limit a running programs impact on other programs, data stored by a computer system, or the computer system itself Some sandbox environments are components of larger computer programs and may be used, for example, to contain plugins or scripted documents. Other sandboxes may be stand-alone or operating system-wide.

### SUMMARY

Computer code to be run in a sandbox environment may be analyzed before loading. The computer code can include instructions that, during execution, move control to a target point determined by data at runtime. Instructions of the computer code that may be the target of this indirect branching can be identified and listed in a branch destination table. For each entry in the table, an associated abstract address can be created. At compile time, an element of the compiler toolchain can provide the abstract address, as opposed to the actual address, to the computer code when it is run in the sandbox environment. In particular, when the running code requests a memory address, the abstracted address is identified. As such, the running computer code may be unable to access memory address of the computer system in which it runs. This can allow, for example, a computer user to run untrusted code in a safe environment without fear that the untrusted code can escape the sandbox.

In general, one innovative aspect of the subject matter described in this specification can be embodied in methods that include the actions of receiving a software module that includes verifiably safe computer code and a branch destination table indicating addresses of all instructions that may be targets of indirect control flow transfers; validating the computer code to determine whether it can run safely by using a statically verifiable fault isolation scheme, where validating the computer code comprises validating the addresses of the branch destination table instructions; and running the computer code, in a sandbox environment, if it has been determined to run safely. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Validating an address within the branch destination table comprises determining whether the address is located within the bounds of a safe executable memory region. Validating an address of a branch destination table instruction comprises verifying that the address is located at the beginning of a code region. The branch destination table comprises a group of entries, each entry comprises an abstract address associated with an instruction's address. The branch destination table was generated at compile time of the verifiably safe computer code; the verifiably safe computer code contains abstract addresses to identify memory locations; and running the computer code comprises resolving, for the computer code, an instruction's address in response to receiving an associated abstract address. The running computer code uses the abstract address as values for indirect control flow transfers that are function pointers and return addresses. The software module is received from a computer program that generated the software module. The computer program is executing on the same computer as the sandbox environment.

In general, one innovative aspect of the subject matter described in this specification can be embodied in methods that include the actions of receiving computer code; generating, based on the computer code, a branch destination table indicating addresses of all instructions in the computer code that may be targets of indirect branches; and creating a software module comprising the computer code and the branch destination table. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Creating the software module comprises placing the branch destination table at a predetermined location within the software module. The method further includes providing the software module to a tool configured to retrieve the branch destination table from the predetermined location.

The systems and techniques described here may provide one or more of the following advantages. A sandbox environment can insulate running computer code from the rest of the computer environment, increasing security and making untrusted code more useful. A compiler toolchain can reliably analyze the code without false positive branch identifications, and can thus create a branch destination table without extraneous entries. Computer code running in a sandbox environment can uniquely identify memory locations without gaining direct access to the memory itself. The sandbox environment can bounds check memory requests before permitting computer code to access memory content.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a diagram of an example system in which a game is served in a webpage.

FIG. 2 is a diagram of an example computer system containing a browser with a native environment.

FIG. 3 is a diagram of an example of a system for analyzing and running computer code within a sandbox environment.

FIG. 4 is a diagram that schematically shows an example control flow of a running program.

FIG. 5 is a flowchart of an example process for running computer code.

FIG. 6 is a schematic diagram that shows an example of a computing system that can be used in connection with computer-implemented methods and systems described in this document.

Like reference symbols in the various drawings indicate like elements.

### DETAILED DESCRIPTION

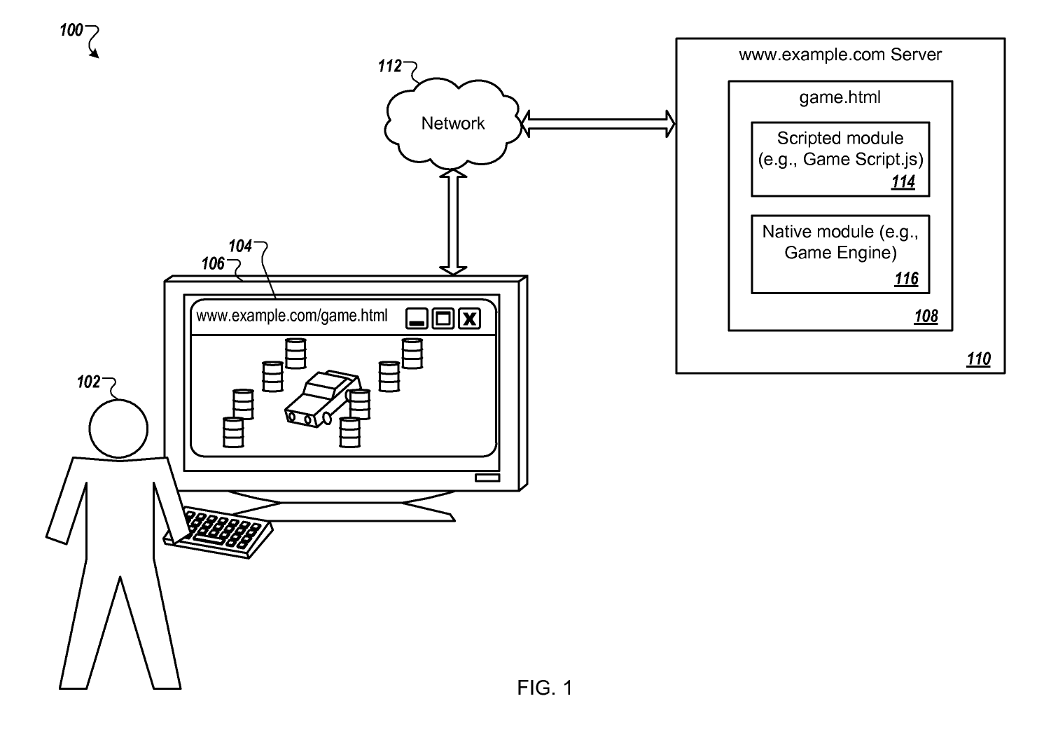

FIG. 1 is a diagram of an example system 100 in which a game is served in a webpage. Here, a user 102 is accessing a webpage that has an embedded video game. The video game has a computationally complex three-dimensional (3D) world with moving elements that are rendered onto a two-dimensional (2D) viewing surface. To process the moving elements and the rendering, the video game has a game engine that runs native code on the user's computer, producing process throughput sufficient to play the game at a desirable speed and quality.

To load the game, the user 102 uses a web-browser 104 on a computer 106 to request a webpage 108 from a web server 110 over a network 112. In this example, the computer is a personal computer, such as a desktop or laptop. However, it will be understood that any type of computer suitable to execute an application may be used in other example. These other computers include, but are not limited to, tablet computers, phones, televisions, game consoles, game cabinets, and kiosk machines.

At the user's direction, the web-browser 104 can request the webpage 108 from the web server 110. The request is passed over the network 112, which may include any suitable wired or wireless network such as a local area network (LAN), a wide area network (WAN) and the Internet. The web server 110 can respond to the request by sending a copy of the webpage 108 back to the web-browser 104 over the network 112.

The webpage 108 in this example is a hypertext markup language (HTML) document that includes at least a scripted module 114 and a native module 116. The HTML portions of the webpage 108 define many portions of the webpage, for example, the layout of elements in the webpage when it is displayed by a web-browser. One such element of the webpage 108 is a game created by the scripted module 114. The scripted module 114 in this example is a JavaScript program, although any appropriate scripting language that is interpreted by a web- browser may be used. The scripted module 114 can handle many of the functions of the game that are not computationally complex, such as user log in, input handling, and an in-game chat with other players.

More complex or time sensitive processes like rendering a 3D world and collision detection can be handled by a game engine created using the native module 116. In this example, the native module is written in c++, although any appropriate programming language that is executed by the web-browser may be used. The native module may be, or may include, off the shelf game engines and graphics libraries, e.g., id Tech 3 or Panda30 and OpenGL or Direct3D, respectively.

When the web-browser 104 receives the webpage 108, the web-browser displays the web-page 108. Displaying the web-page 108 can include one or more of rendering the HTML, interpreting the scripted module 114, or executing the native module 116. The web-browser 104 has a number of mechanisms to protect the computer 106 from any potential malicious or erroneous functionally of the web-page 108. For the HTML rendering, user-options may be set to restrict behavior that the user 102 may not want, e.g., storing cookies. For the script interpreting, the scripting language or interpreter may not support potentially dangerous functionality like reading or writing to a hard drive. For the native code execution, the web-browser 104 can execute the native module 116 in a sandbox. A sandbox is a managed environment in which a subset of the computer's 106 resources are available and in which security measures ensure running code behaves in a desired way. For example, the sandbox may have access to only one directory of disk memory, a pre-allocated memory buffer, and a subset of operating system or processor application programming interfaces (APIs). Additionally or alternatively, the sandbox may have a memory addressing indirection scheme under which actual memory address are hidden from running code.

The native module 116, and any other untrusted native code, can execute in the sandbox at, or near, the speed of native code executed outside of the sandbox. By executing the native module 116 in the sandbox, the browser can protect the rest of the computer 106 from untrusted native code without significantly diminishing the performance of the native module 116. As such, the developers of the game are able to embed games and other resources into webpages for display on a browser, and a user is able access the game without worrying that it will affect the user's computer.

Although a video game was used in this example, the system 100 can also be used for distributing other types of applications. Another example includes text-to-speech in which a scripted module sends page text to a native module and the native module generates a sound emulating a voice speaking the text, an embedded interpreter in which an arbitrary scripting language is used to create the scripted module and the native module is an interpreter for the arbitrary scripting language. Other uses include, but are not limited to, media players that are able to use hardware acceleration, remote desktop and virtualization services, computer aided drafting programs, and teleconferencing applications.

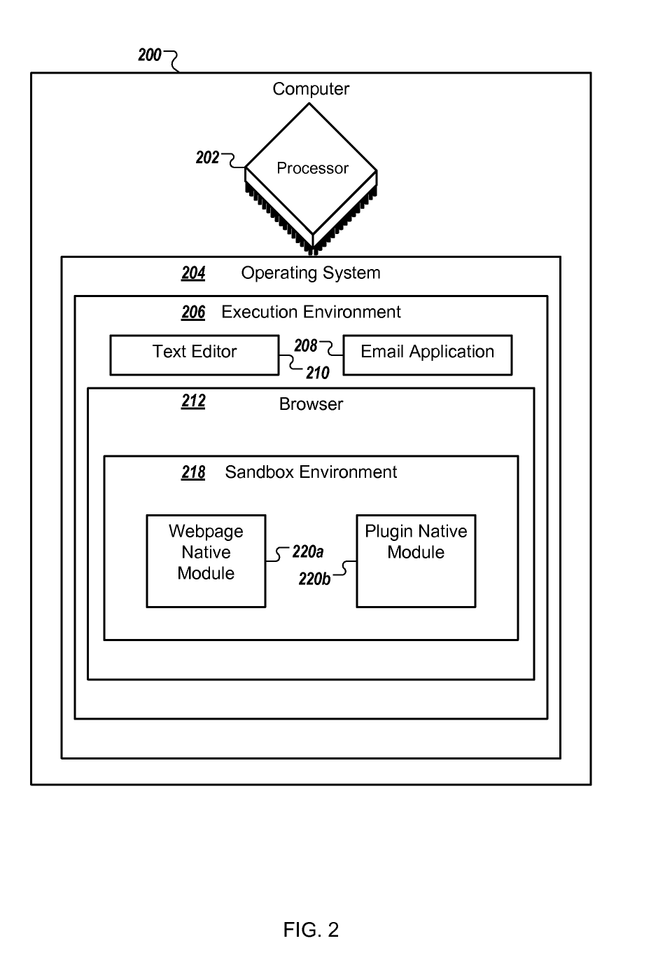

FIG. 2 is a diagram of an example computer system 200 containing a browser with a native environment. The computer system 200 may be used for, for example, downloading and displaying a webpage with a scripted module and a native module.

The computer system 200 includes hardware components including, but not limited to, a processor 202. The processor 202 can be configured to carry out instructions of computer programs and to perform arithmetic, logical, and input/output operations of the computer system 200. Other hardware components that may be included in the computer system 200 include, but are not limited to, main memory, disk memory, input/output hardware, and network connections (not shown for clarity). The hardware of the computer system 200 runs an operating system 204 that manages computer hardware resources and provides common services for application software. The operating system 204 may be a general purpose operating system that is compatible across a variety of hardware configurations, or the operating system 204 may be system-specific. Some of the tasks that the operating system 204 may be responsible for include, but are not limited to, user authentication, windowing, and managing network traffic.

The operating system 204 can create an execution environment 206 for executing one or more applications. The execution environment 206 can represent the conditions, policies, and tools that the operating system 204 provides to applications executing in the operating system 204. Although one execution environment 206 is shown, some computer systems 200 can create multiple execution environments 206. For example, a computer system 200 may have many users, and the computer system 200 can create an execution environment for each user. The execution environments 206 may not all be the same. For example, an execution environment 206 for an administrative user may have more permissions enabled than an execution environment 206 for a non-administrative user.

Applications that can execute in the execution environment 206 can include user-facing applications, for example, an email application 208, a text editor 210, and a browser 212. Other types of application that are not user-facing, e.g., utilities daemons, may also execute in the execution environment 206. The applications in the execution environment 206 can execute computer-specific commands. Computer-specific commands include any function, library, API, or other command that is compatible with the computer system 200, but that may not be compatible with other computer systems.

One type of computer-specific command is a processor-specific command. Processor-specific commands are commands that are associated with one or more processors. Often, the processor-specific commands are part of an instruction set associated with a processor architecture, though not always. One group of processor-specific instructions is the x86 family of instruction sets. Example processor-specific instruction in the x86 family of instruction sets include AND for a logical “and”, CBW for converting a byte to a word, STI for setting an interrupt flag, and SUB for subtraction. Other example processor instruction sets include the ARM instruction set and the PowerPC instruction set.

Another type of computer-specific command is an operating system-specific command. Operating system-specific commands are commands that are associated with one or more operating systems. Operating system-specific commands are often organized into APIs related to a particular concept or task. For example, some Unix-based operating systems include an API for sockets and another API for shared memory management. Other operating system-specific commands include files and features often or always found in an operating system. For example, the /dev/random file in some Unix-based operating systems servers as a pseudorandom number generator.

Other types of computer-specific commands can exist. For example, a hardware device connected to the computer system 200 may have associated commands. The complete set of all computer-specific commands available in the execution environment can include processor-specific commands, operating system-specific commands, and other commands. The number and type of processor-specific commands may depend on the configuration of the computer system 200, as well as other factors.

A shown in FIG. 2, the browser 212 executes in the execution environment 206 and may access some or all of the computer-specific commands of the execution environment 206. The browser 212 can load and display documents, e.g., files or other data, to a user. In doing so, the browser 212 may need to render, interpret, and/or execute portions of the documents. Examples of the browser 212 include, but are not limited to, file browsers, document editors, and web-browsers.

The browser 212 can also create a sandbox environment 218 for executing received native modules 220. The native modules 220 may come from a variety of sources. For example, native module 220a may be component of a document being loaded and displayed by the browser 212 and native module 220b may be a plugin of the browser 212. Native modules, as the term is used here, may refer at least to modules that can be configured to execute computer-specific commands. The native modules 220 may be written in a computer-specific programming language such as c or c++ and may contain binary data created by compiling the source code into computer-specific commands. While this example will discuss native modules 220 configured to execute computer-specific commands, it will be understood that other types of modules may be used. For example, for an interpreter using just-in-time (JIT) compilation configured to comply with the rules discussed in this document, an interpreted module may be used.

The sandbox environment 218 may be an environment that is similar to an execution environment 206 that limits the types of computer-specific commands that are permitted. For example, the sandbox environment 218 may intercept the commands and messages and of the native modules 220 and alter or prevent some of the commands and messages. For example, the sandbox environment 218 may intercept messages to and from the native modules and replace memory address values with other values. In some implementations, a white list of permitted commands and messages is established for a sandbox environment 218 and only those commands and messages are permitted. In some implementations, a black list of restricted commands and messages is established for the sandbox environment 218 and those commands are denied. Other configurations of the native environment are possible. For example, the sandbox environment 218 may prevent cross-process messaging and may isolate software faults.

In some implementations, the sandbox environment 218 performs one or more actions when loading the native modules 220. These actions may ensure, for example, that the native modules 220 conform to certain heuristics, do not include forbidden functionality, or may extract information from the native modules 220.

One type of information that may be extracted is a listing of all instructions within the native modules 220 that may be the target of indirect control flow transfers, including branches of execution. An indirect branch, also sometimes known as a computed jump, indirect jump, or register-indirection jump, may specify a jump to an instruction whose address is stored at a location, as opposed to identifying the address directly. For example, a pointer value that is dynamically allocated during runtime may be used to address an indirect jump. That is, static analysis may include inspecting the code and computing properties about the code without running the code. This contrasts with other analysis technique such as symbolic execution, where the program is given a simulated run but is interpreted with variables (memory) containing a symbolic representation of what the variables may contain, or dynamic analysis where the code is analyzed by running with different test input using an instrumented version of the code or by running the code in a special environment. Other types of indirect control flow transfers include return operations, some RET opcodes and some calls to virtual functions. Indirect control flow transfers also include jump tables, for example, of switch statements, Fortran's assigned gotos, alternate returns, computed gotos, gcc's address of labels C extensions.

These instructions that may be the target of indirect branches may be listed in a branch destination table in the native modules 220. For each of these instructions, the branch destination table may also store an abstract address. The abstract address may be, for example, a unique bit string or value that is not an address of memory. In some cases the abstract address may have the same format as a real memory address, or the abstract address may have a different format. In some cases, abstract addresses may be the index values of a data structure, including the index values of the branch destination table. In any case, running code within the sandbox may be unable to use the abstract address to locate an instruction or any other stored data in memory. The size of the branch destination table may be made over-large, for example, by duplicating one or more entries. This branch destination table may have been generated, for example, by a compiler toolchain used to generate the native module 220. The branch destination table's entries can be thought of as forming nodes in the control flow graph.

In some cases, the branch destination table may be stored in an archive or other composite file with the native module 220. The branch destination table and/or the code of the native module 220 may be stored at either a particular name or location for future access. The sandbox environment 218 or any other analysis tool (e.g., a validator) may then be able to locate the desired portion at that particular name or location. In another configuration, the branch destination table may be at a random location, with the location of the branch destination table recorded at a predetermined location.

When the native module 220 is run and needs a reference to a memory address, the sandbox environment 218 can receive a request from the native module 220 and provide the native module 220 with an abstract address instead of a true memory address. In pseudo-assembly code for a 32-bit architecture where the abstract address is held in an register X and the abstract address are indices (as opposed to offsets), such instructions may be:
load X, [table_base+X* sizeof(address)]
jmp*X

The native module 220 may receive an abstract address in at least one of three ways. A static address may be generated by a linker, compiler, or runtime code generator used by or used to create the native module 220. In some of these cases, the linker, compiler or code generator may assign a unique number to all indirect branch targets. Further, statistical prediction may be used to identify return-sites after calls and setjmp commands, or the equivalent. For returns, a calling function of the native module 220 may pass the abstract address of the return site to the called procedure. On architectures with a dedicated CALL instruction that has performance benefits (such as some x86), the abstract return address may be passed as an additional parameter and the called procedure may ignore the hardware-generated return address on the stack. On some architectures without special CALL instructions, e.g., ARM, native modules 220 may choose to use a simple branch into the called procedure, passing the abstract return address in the register or on the stack. In any case, the caller selects the abstract return address for the callee. The native module 220 may then store, manipulate, and pass abstract address as function parameters the same way real addresses can be used. For example, accessing jump tables from switch statements (with dense label values) can be done using code that uses arithmetic on a switch expression to compute the abstract address.

While the example shown involves a sandbox environment as an element of a browser, any type of sandbox environment may be used. For example, a stand-alone virtual machine may have a similar configuration to handle applications distributed through other channels. A sandbox environment may be the only execution environment available to user-level applications so that every application a user loads and runs is subject to sandbox environmental management.

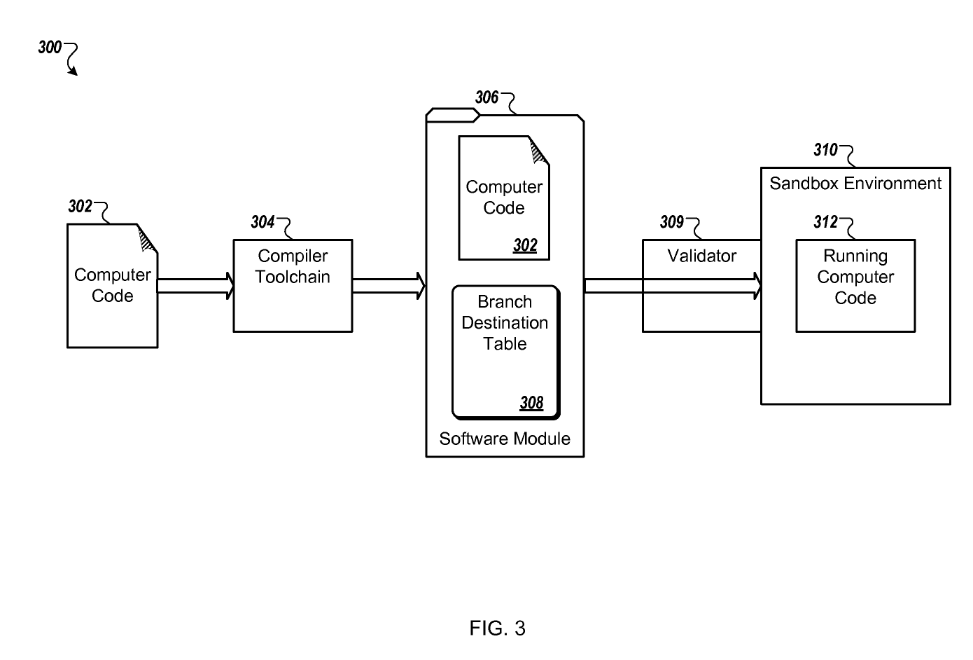

FIG. 3 is a diagram of an example of a system 300 for analyzing and running computer code within a sandbox environment. The system 300 may be used by any appropriate computing device or system of computing devices in order run untrusted code within a managed environment. For example, the system 300 may be used by a desktop computer system that has received code from an unknown, and thus untrusted, source. In another example, a medical device may have a set of function that should only be accessed under certain conditions, and the medical device may use the system 300 to run code with the assurance that those functions will not be invoked if the device is not in the appropriate conditions.

Computer code 302 can include any type of machine code or interpreted instructions configured to be run on a computing device. The computer code 302 may include, but is not limited to, compiled machine instructions that are specific to a particular machine or architecture or script code that is distributed in script format or in an intermediary format e.g., bytecode. The system 300 may receive the computer code 302 from any number of sources, for example, downloading from the internet, loading from a portable storage medium, or purchasing from an application store.

The computer code 302 is loaded into a compiler toolchain 304. The compiler toolchain 304 identifies all instructions within the computer code 302 that may be the target of indirect braches. As the toolchain 304 may have access to all control flow transfers, it may be able to identify the indirect branches. The addresses of these target instructions may be listed in a branch destination table 308 by the compiler toolchain 304. For each instruction address, the compiler toolchain 304 may also list an associated abstract address in the branch destination table 308. These abstract address may be generated, for example, by sampling a pseudo-random number source, hashing some data, by sequential assignment, or another scheme. In some implementations, it may be advantageous to use a dense assignment so that a direct table lookup is efficient. For example, if a switch statement may have case levels 0, 1, 10, branch values may be ranged checked from 0 to 10, inclusive and a base branch destination table index value can be added to the switch expression. In this case, code blocks at entries 2-9 may contain the address of the default code block or statement following the switch statement.

The compiler toolchain 304 can use disassembly to examine at the basic blocks that start at each address in the branch destination table and construct a control flow supergraph, that is, a control flow graph that contains the actual program control flow. In some cases, any basic block starting addresses for indirect control flow transfers may be permitted, as opposed, say, only address at 0 mod 32.

The compiler toolchain 304 can combine the computer code 302 and the branch destination table 308, and possibly other data, into a software module 306. Depending on the format of the software module, the computer code 302 and/or the branch destination table 308 may be a named section or at a well-known address within the software module. This may enable, for example, retrieval of a component of the software module 306.

The software module 306 may be loaded into an execution environment, for example, a sandbox environment 310. In some cases, this is the result of a user input, e.g., a user typing a command into a command prompt or clicking on an icon for the computer code 302. In some other cases, the sandbox environment 310 automatically loads the software module, e.g., an application with a computer code 302 plugin may send a request to the sandbox environment 310.

As an initial step of loading the software module 306, a validator 309 can validate the software module to determine if the software module 306 includes the branch destination table 308 and that the computer code 302 uses the branch destination table 308. For example, the validator 309 may check the computer code 302 to determine if the instructions exclusively use the branch destination table 308 in order to make indirect control flow transfers. If the software module 306 is not validated by the validator, it may be discarded. For example, the loading of the software module 306 may be delayed or prevented, an error message may be generated, and/or the failure may be communicated to a user. If the software module 306 is validated, the sandbox environment 310 can retrieve the branch destination table 308 and launch an instance of the running computer code 312. The sandbox environment 310 may then permit the running computer code 312 to run, subject to the policies of the sandbox environment 310.

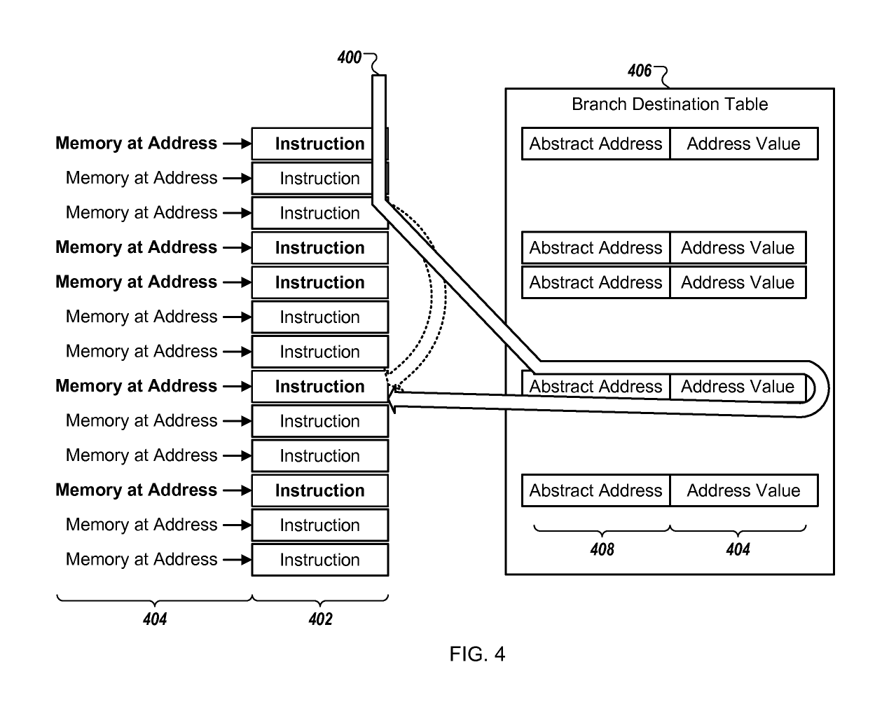

FIG. 4 is a diagram that schematically shows the control flow 400 of a running program. The control flow 400 shows the sequence of instructions 402 of running program that are executed, for example by a processor and under the supervision of a sandboxing environment. Each instruction 402 has an associated address 404 that may be, for example, a memory address at which the instruction is stored in random access memory (RAM).

The instructions 402 and addresses 404 that may be the target of indirect branching are shown here in bold. That is, the bold instructions 404 are those instructions which another instruction may branch to. In this example, it is possible that, due to the values of runtime data, the flow control 400 may branch to a different bolded instruction 404 than the one shown.

Each such instruction 402 has a matching entry in a branch destination table 406, which maps addresses 404 to abstract addresses 408. This branch destination table 406 may have been created, for example, by a compiler toolchain or code analysis engine prior to the running of the program. The sandbox environment may be configured to only provide the abstract addresses 408, and not addresses 404, to the running program. Although every instruction 402 that may be the target of indirect branching has a matching entry in the branch destination table 406 in this example, this may not be required in other examples, For example, only instructions that are at the start of a basic block may have a matching entry in a different branch destination table.

The control flow 400 enters the program, in this case at the main entry point (e.g., the main() function in c code), and proceeds to step through the instructions 402 sequentially until an instruction requiring a memory address is reached. For example, the instruction may include a call to a static function pointer generated by the linker that linked the program. Instead of gaining direct access to the address 404 stored in the pointer as shown by the dotted arrow, the sandbox environment can provide the program with the associated abstract address 408. A call by the program to the abstract address 408 location may be intercepted by sandbox environment and modified with the address 404, and the control flow 400 can then proceed to the instruction 402 of the address 404.

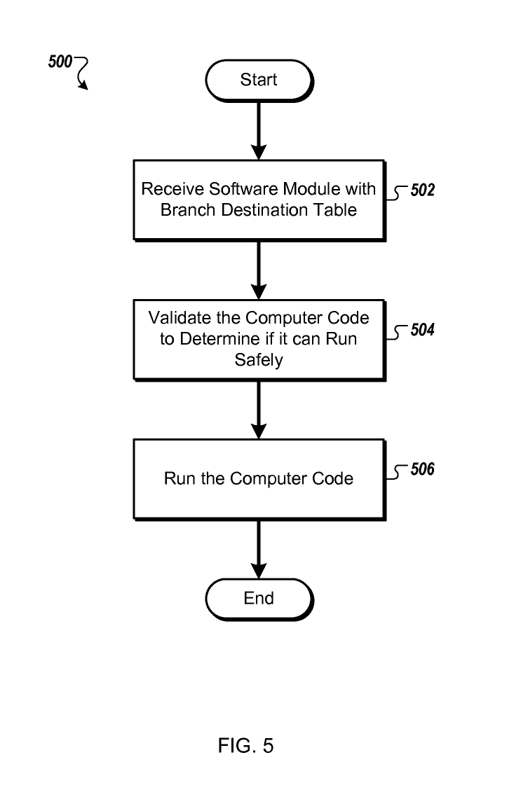

FIG. 5 is a flowchart of an example process 500 for running computer code. For convenience and clarity, the process 500 will be described as being performed by a system including one or more computing devices, for example the computer system 200. Therefore, the description that follows uses the computer system 200 as the basis of an example describing the system for clarity of presentation. However, another system, or combination of systems, can be used to perform the process.

A software module that includes verifiably safe computer code and a branch destination table indicating addresses of all instructions that may be targets of indirect branches is received (502). For example, code that is verifiable safe may be code that may be subject to one or more heurists, tests, or analysis designed to determine if the software module is safe or not. The determination may be probabilistic or absolute, and may only test for some definitions of safe. That is, a test to identify all indirect branching within the computer code may not test, for example, to see if the computer code has virus like propagation functionality.

The software module may have been received from a computer program that generates the software module (e.g., native module 220). For example, the computer program may package the computer code into an archive or executable file, possibly along with other files. One of these other files may be the branch destination table. In some cases, the software module may also produce the branch destination table, for example by analyzing the computer code.

The computer code is validated (504) by using a statically verifiable fault isolation scheme to determine whether the computer code can run safely. Validating the computer code comprises validating the addresses of the branch destination table instructions. For example, the computer program, a validator (e.g. validator 309) or a sandbox environment (e.g., sandbox environment 218) may use static analysis to validate the software module. This may include using a reliable disassembly to find direct control flow transfers starting at the beginning of a basic block addressed by the branch destination table to compute a control flow supergraph to ensure that all direct control flow transfers do not, for example, branch to the middle of an instruction, to ensure that all indirect control flow transfers follow defined rules, and to ensure that fall through control flow transfers do not cause de-registered interpretation of instructions. For example, the disassembly decoding may find that a basic block ends exactly where another block begins.

Validating can include determining whether the address is located within the bounds of a safe executable memory region. For example, the computer program or sandbox environment may have a policy to prevent computer code from accessing memory that is not a part of, or allocated for, that particular computer code. This bounds checking may ensure that no instructions of the computer code attempt to access other memory location and thus violate that policy.

Validating can, in some cases, further include verifying that the address is located at the beginning of a verifiably safe executable machine code instruction area. These areas may be variable-sized bundles or contiguous code regions. The instruction areas, for example, may be larger than basic blocks. The start of each instruction area may be reached by different events in execution, including fall through from the immediately preceding contiguous code region, by the start address for the application, or by the use of the branch destination table by looking up an abstract address.

The computer code is run (506) in a sandbox environment if it has been determined to run safely. For example, upon approval, the sandbox environment may execute, interpret, or otherwise run the computer code according to the configuration of the computing environment. The sandbox may provide security features, e.g., code validation; cross-platform features, e.g., a common interface for network communications on different platforms; and/or managed execution features, e.g., garbage collection.

Running the computer code can include providing, to the computer code, an abstract address in response to a request for an associated instruction's address and resolving for the computer code, an instruction's address in response to receiving an associated abstract address. For example, the sandbox can monitor and intercept actions of the running computer code that include

Running the computer code can further include using, by the running computer code, the abstract address as values for function pointers and return addresses. For example, many programming languages provide for function pointers to identify the location in memory of a function and for return addresses to identify where the control flow of a program should return to after a function is complete. Instead of providing the running computer code with the actual addresses for the function pointers and return address, the sandbox environment may instead provide the abstract addresses that are associated with the memory addresses. The program may then store and use the abstract addresses as it would the actual address.

The software program may be run on the same computer as the sandbox environment. For example the sandbox and the software program may be part of the same sandbox package that may receive the computer code, build the branch destination table, validate the computer code, and run the computer code. However, in some implementations, the computer program may be on a different computer than the sandbox environment. For example, the computer code may be provided by the code developer to a central market or repository. Users may, for example, browse the repository's catalog of available computer code and download a software module that contains the computer code and the branch destination table. Other configurations are possible, including a cluster or distributed computing environment in which the computer program and the sandbox may or may not be on the same computer, depending on how tasks are allocated.

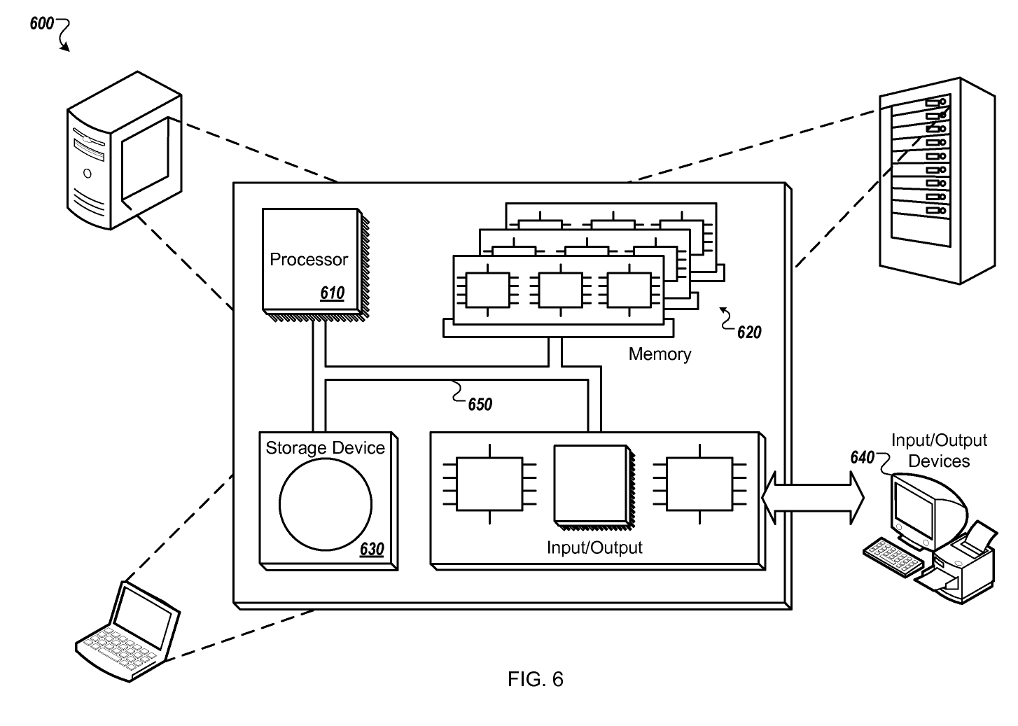

FIG. 6 is a schematic diagram that shows an example of a computing system 600. The computing system 600 can be used for some or all of the operations described previously, according to some implementations. The computing system 600 includes a processor 610, a memory 620, a storage device 630, and an input/output device 640. Each of the processor 610, the memory 620, the storage device 630, and the input/output device 640 are interconnected using a system bus 650. The processor 610 is capable of processing instructions for execution within the computing system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the computing system 600. In some implementations, the memory 620 is a computer-readable medium. In some implementations, the memory 620 is a volatile memory unit. In some implementations, the memory 620 is a non-volatile memory unit.

The storage device 630 is capable of providing mass storage for the computing system 600. In some implementations, the storage device 630 is a computer-readable medium. In various different implementations, the storage device 630 may be a floppy disk device, a hard disk device, an optical disk device, or a tape device.

The input/output device 640 provides input/output operations for the computing system 600. In some implementations, the input/output device 640 includes a keyboard and/or pointing device. In some implementations, the input/output device 640 includes a display unit for displaying graphical user interfaces.

Some features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, some features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

Some features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

What is claimed is:

1. A computer-implemented method comprising:
receiving a software module that includes verifiably safe computer code and a branch destination table indicating addresses of all instructions that may be targets of indirect control flow transfers;
validating the computer code to determine whether it can run safely by using a statically verifiable fault isolation scheme, where validating the computer code comprises validating the addresses of the branch destination table instructions; and
running the computer code, in a sandbox environment, if it has been determined to run safely.

2. The method of claim 1, wherein validating an address within the branch destination table comprises determining whether the address is located within the bounds of a safe executable memory region.

3. The method of claim 2, wherein validating an address of a branch destination table instruction comprises verifying that the address is located at the beginning of a code region.

4. The method of claim 1, wherein the branch destination table comprises a group of entries, each entry comprises an abstract address associated with an instruction's address.

5. The method of claim 4, wherein the branch destination table was generated at compile time of the verifiably safe computer code;
wherein the verifiably safe computer code contains abstract addresses to identify memory locations; and
wherein running the computer code comprises resolving, for the computer code, an instruction's address in response to receiving an associated abstract address.

6. The method of claim 5, wherein the running computer code uses the abstract address as values for indirect control flow transfers that are function pointers and return addresses.

7. The method of claim 1, wherein the software module is received from a computer program that generated the software module.

8. The method of claim 7, wherein the computer program is executing on the same computer as the sandbox environment.

9. A computer-implemented method comprising:
receiving computer code;
generating, based on the computer code, a branch destination table indicating addresses of all instructions in the computer code that may be targets of indirect branches; and
creating a software module comprising the computer code and the branch destination table.

10. The method of claim 9, wherein creating the software module comprises placing the branch destination table at a predetermined location within the software module.

11. The method of claim 10, further comprising providing the software module to a tool configured to retrieve the branch destination table from the predetermined location.

12. A computer system comprising:
one or more processors; and
a computer-readable medium having stored therein instructions that when executed generate a software validator and a sandbox environment;
wherein the software validator is configured to:
receive a software module that includes verifiably safe computer code and a branch destination table indicating addresses of all instructions that may be targets of indirect branches;
validate the computer code to determine whether it can run safely by using a statically verifiable fault isolation scheme, where validating the computer code comprises validating the addresses of the branch destination table instructions
provide the software module, after validation, to a sandbox environment; and
wherein the sandbox environment is configured to:
run the computer code, in a sandbox environment, if it has been determined to run safely.

13. The system of claim 12, wherein validating an address within the branch destination table comprises determining whether the address is located within the bounds of a safe executable memory region.

14. The system of claim 12, wherein the branch destination table comprises a group of entries, each entry comprises an abstract address associated with an instruction's address.

15. The system of claim 14, wherein running the computer code comprises:
providing, to the computer code, an abstract address in response to a request for an associated instruction's address; and
resolving, for the computer code, an instruction's address in response to receiving an associated abstract address.

16. The system of claim 15, wherein the running computer code uses the abstract address as values for function pointers and return addresses.

17. The system of claim 12, wherein the software module is received from a computer program that generated the software module.

18. The system of claim 17, wherein the computer program is executing on the same computer as the sandbox environment.

19. A computer storage medium encoded with a computer program, the program instructions that when executed by one or more computers cause the one or more computers to perform operations comprising:
receiving a software module that includes verifiably safe computer code and a branch destination table indicating addresses of all instructions that may be targets of indirect branches;
validating the computer code to determine whether it can run safely by using a statically verifiable fault isolation scheme, where validating the computer code comprises validating the addresses of the branch destination table instructions; and
running the computer code, in a sandbox environment, if it has been determined to run safely.
